(19) United States
(12) Patent Application Publication
(10) Pub. No.: US 2009/0014980 A1
(43) Pub. Date: Jan. 15, 2009

(54) Front Fork for Bicycles

(76) Inventor: Louis Chuang, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/775,945

(22) Filed: Jul. 11, 2007

(51) Int. Cl. B62K 21/02

(52) U.S. Cl. 280/279

(57) ABSTRACT

A front fork for a bicycle includes a bridge installed between a pair of tubes. A compartment is formed in the bridge. An adapting device which fits into the compartment is connectable with a bicycle peripheral product and adapted to allow a quick engagement and a quick disengagement of the bicycle peripheral product.

### BACKGROUND OF THE INVENTION

1. Field of the Invention

The present invention relates to a front fork for a bicycle, in particular, to such a front fork that is firmly connectable to bicycle peripheral products.

2. Description of the Related Art

Referring to Taiwan Patent No. M308226, a front fork for a bicycle includes a pair of supporting lugs extending from a bridge. The supporting lugs are provided to allow a head light installed therebetween. The head light is threadly connected by fasteners and can be adjusted by pivoting about the fasteners. However, the fasteners can get loose from the supporting lugs due to vibration of the front fork caused by riding the bicycle, thus causing the head light to wobble between the supporting lugs. In this case, riding in the dark can be unsafe. Further, the supporting lugs are not connectable to other bicycle peripheral products.

Referring to Taiwan Patent No. D111693, a front fork for a bicycle is detachably connectable with a head light. However, the front fork can not have any other peripheral products connected thereon.

The present invention is, therefore, intended to obviate or at least alleviate the problems encountered in the prior art.

### SUMMARY OF THE INVENTION

A front fork for a bicycle in accordance with the present invention includes a bridge installed between a pair of tubes. A compartment is formed in the bridge. The compartment includes a back wall and a bottom wall. An adapting device fits into the bottom wall of the compartment. The adapting device includes a hooking portion provided to clench a bicycle peripheral product. Further, the adapting device includes a base abutted by the bottom wall of the compartment and a backside abutted by the back wall of compartment.

It is an objective of this invention to provide a front fork having a compartment on which an adapting device can firmly mount and the adapting device is connectable with a bicycle peripheral product.

Other objectives, advantages, and novel features of the invention will become more apparent from the following detailed description when taken in conjunction with the accompanying drawings.

### BRIEF DESCRIPTION OF THE DRAWING

FIG. 1 is a fragmentary, perspective view of a bicycle equipped with a front fork in accordance with an embodiment of the present invention.

FIG. 2 is an exploded perspective view of FIG. 1.

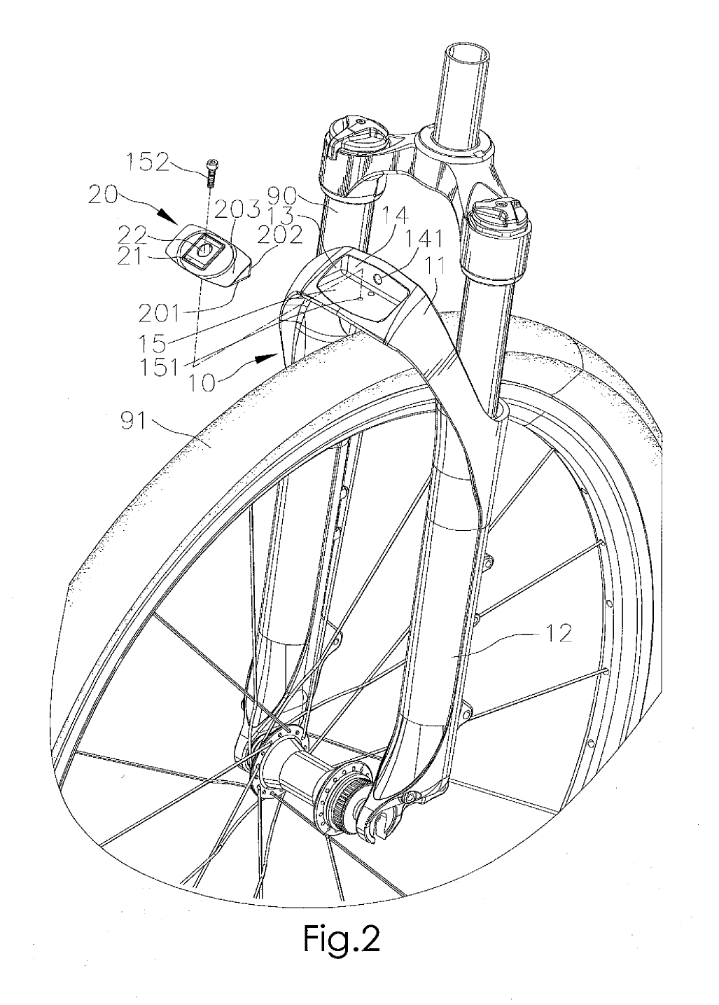

FIG. 3 is a side elevation, partial sectional view of FIG. 1.

FIG. 4 is a perspective view of the front fork equipped with a head light.

FIG. 5 is an exploded perspective view of FIG. 4.

FIG. 6 is a perspective view of the front fork equipped with another head light.

FIG. 7 is an exploded perspective view of another embodiment

### DETAILED DESCRIPTION OF THE PREFERRED EMBODIMENT

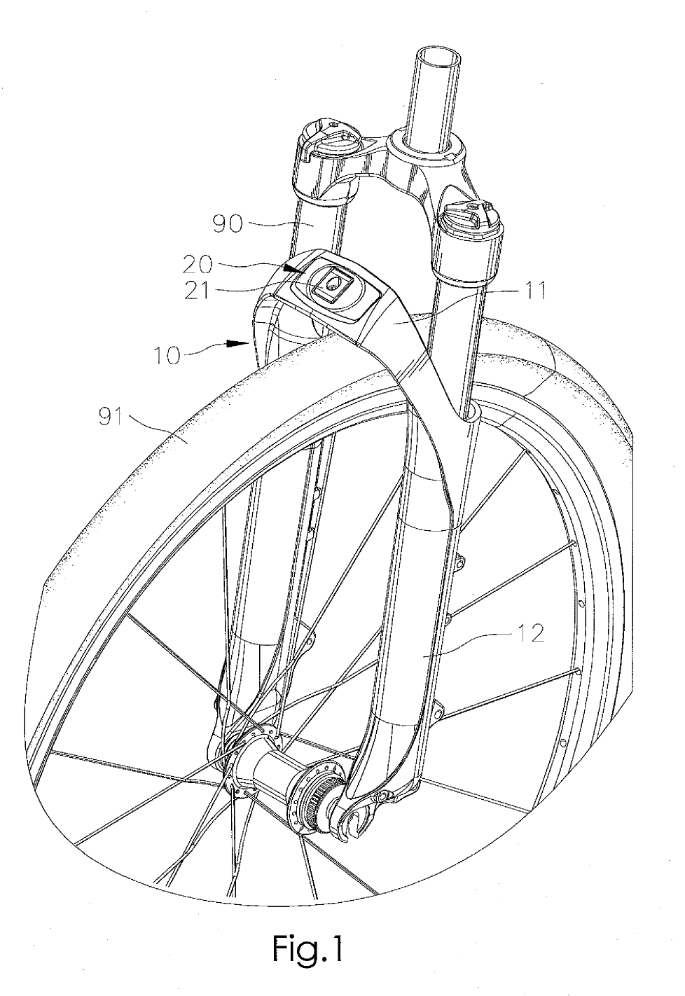

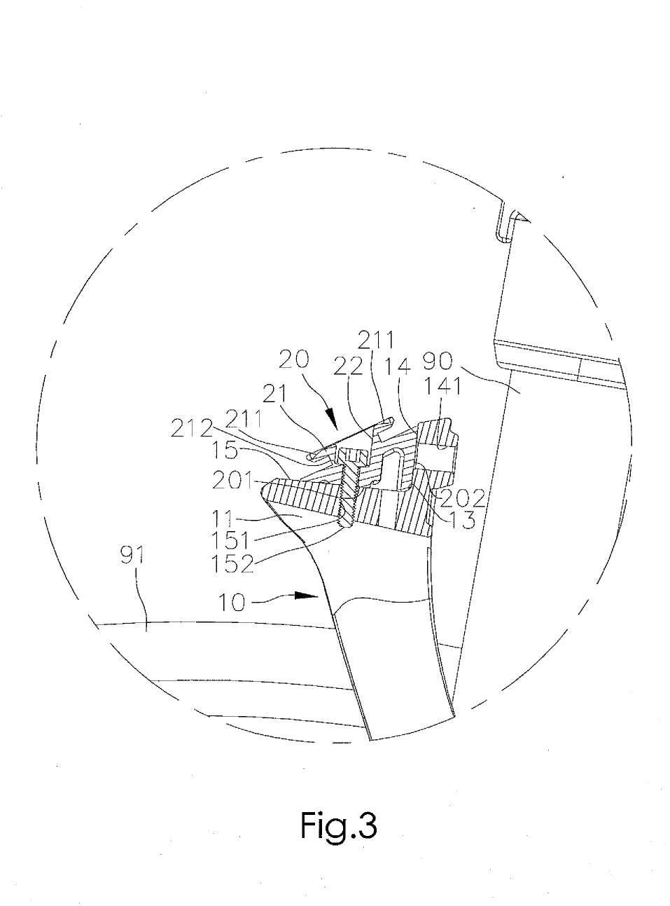

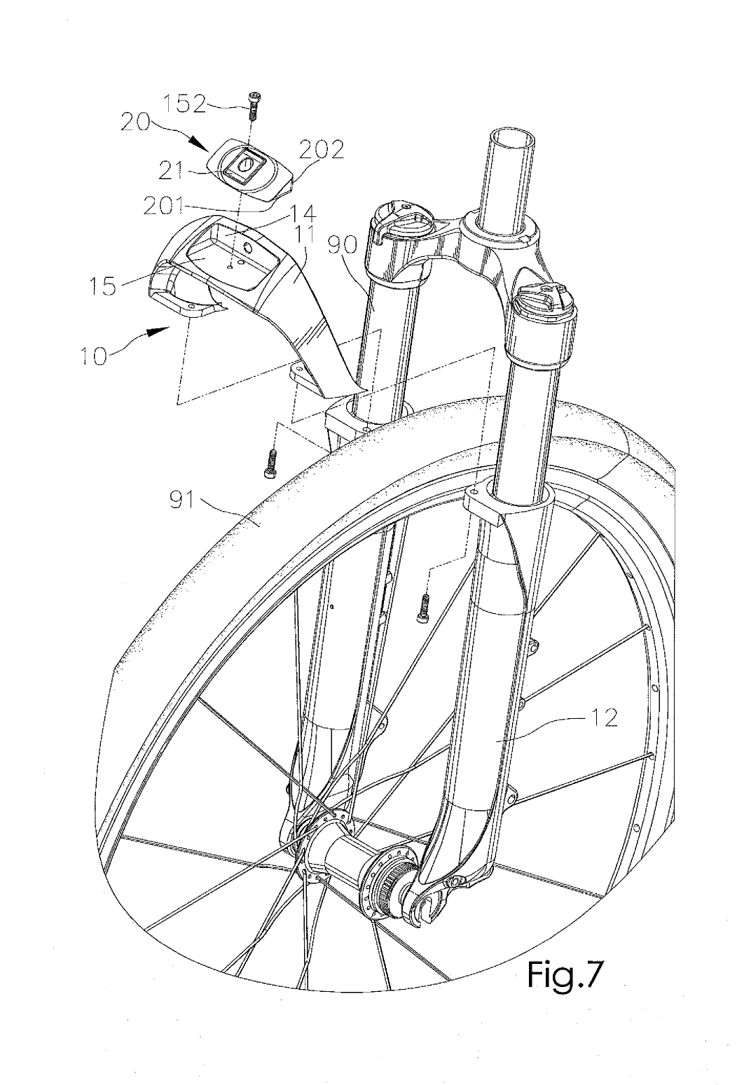

Referring to FIGS. 1 and 3, a front fork 10 for a bicycle includes a bridge 11 installed between a pair of tubes 12 and is configured in the form of an inverted U. The bridge 11 and tubes 12 may be integrally formed or formed in two parts, as shown in FIG. 7. A pair of inner tubes 90 is received in the pair of tubes 12. As a front wheel 91 of a bicycle turns, the pair of inner tubes 90 and tubes 12 will be turned in response to the turning of the front wheel 91.

A compartment 13 is formed in the bridge 11. The compartment 13 includes a back wall 14 and a bottom wall 15 on which an adapting device 20 can mount. The back wall 14 includes a through hole 141 adapted to allow installation of a conventional head light in the compartment 13. Preferably, the through hole 141 may be threaded. The bottom wall 15 includes an engagement hole 151 that is threadly receivable by a fastener 152 according to the preferred embodiment. However, other means for engaging the fastener 152 in the engagement hole 151 is still within the spirit of the invention. Moreover, the compartment 13 defines an open space of a wedge-shaped configuration.

In the preferred embodiment, the adapting device 20 is mounted in the compartment 13. The adapting device 20 includes a base 201 abutting against the bottom wall 15 and a backside 202 which abuts against the back wall 14. Furthermore, the adapted has a sloped side 203 which connects between the base 201 and backside 202. As such, the adapting device 20 is formed having a wedge-shaped configuration. The adapting device 20 also includes a hooking portion 21 extended from the sloped side 203 thereof. The hooking portion 21 has a neck 212 and at least two arms 211 provided to clench a bicycle peripheral product and allow a quick engagement and quick disengagement of the peripheral product. Each arm 211 is parallel to the sloped side 203 and disposed on the neck 212. Further, each arm 211 extends beyond the peripheral edge of the neck 212. The adapting device 20 also includes an orifice 22 receivable by the fastener 152. Thus, in this embodiment, the fastener 152 is inserted though the orifice 22 and threadly engaged in the engagement hole 151 such that the adapting device 20 is firmly fixed in the compartment 13.

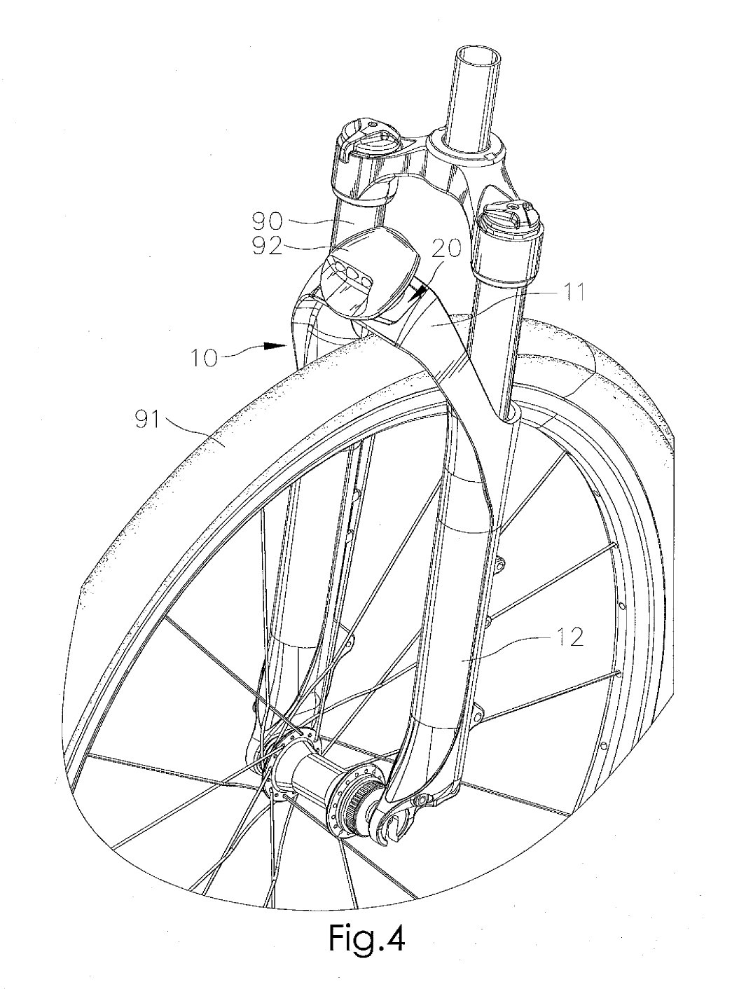

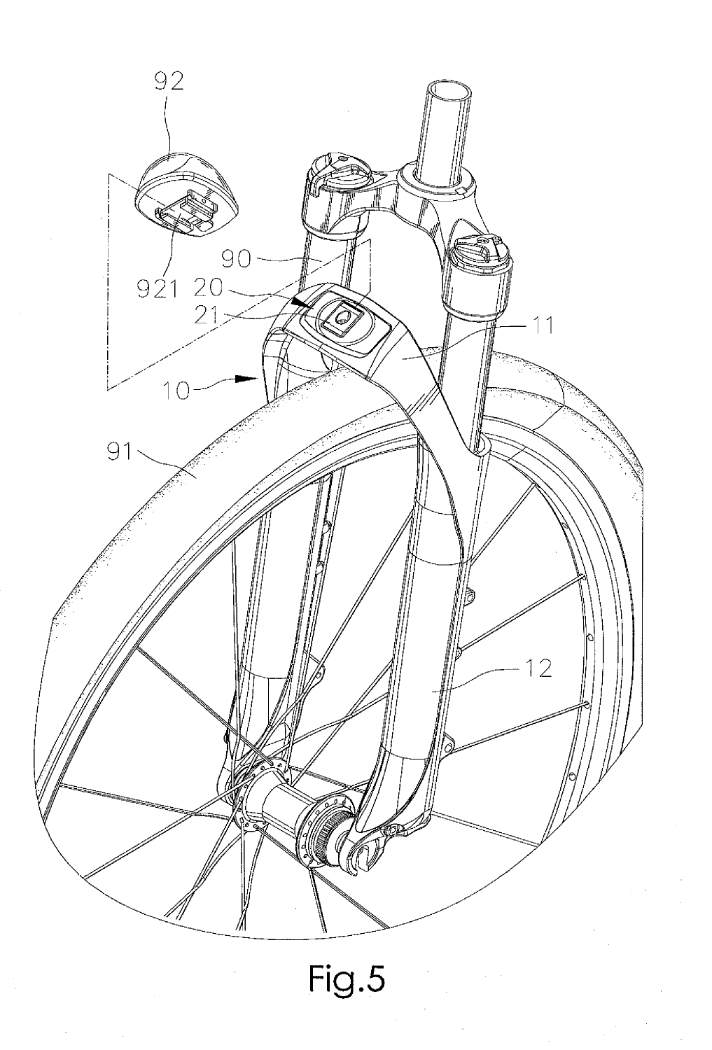

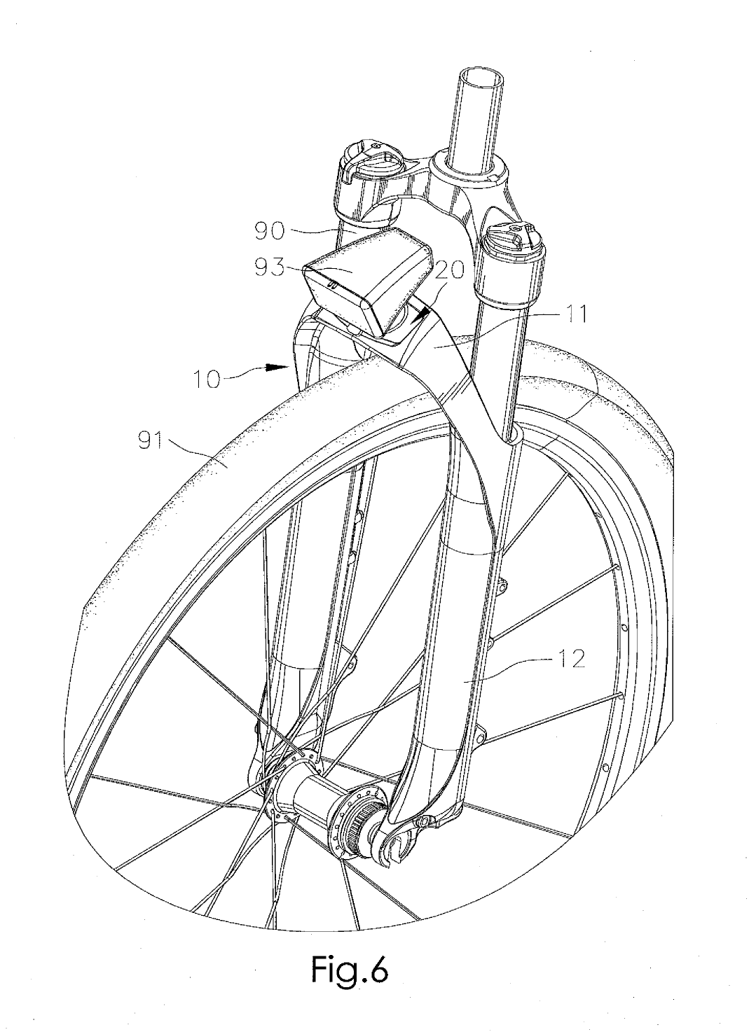

FIGS. 4 and 5 show the front fork 10 is equipped with a head light 92. The head light 92 includes a connecting portion 921 adapted to engage with the hooking portion 21. FIG. 6 shows the hooking portion 21 is adapted for installation of a head light 93.

FIG. 7 show a second embodiment of the invention, in this embodiment, the bridge 11 and tubes 12 is formed in two parts.

Accordingly, it is one aspect of this invention that the front fork 10 includes the compartment 13 on which the adapting device 20 can firmly mount.

As another aspect of the invention, the front fork 10 turns in response to the turning of the front wheel 91, so that the head light 92, 93 will not be blocked by any bicycle part. Thus, riding in the dark is safe.

While the specific embodiments have been illustrated and described, numerous modifications come to mind without significantly departing from the spirit of invention and the scope of invention is only limited by the scope of accompanying claims.

What is claimed is:

1. A front fork for bicycles comprising:
a bridge installed between a pair of tubes;
a compartment being disposed in said bridge, with said compartment defining a bottom wall;
an adapting device including a hooking portion being mounted on said bottom wall of said compartment, with said bottom wall including an engagement hole receivable by a fastener; and
wherein said hooking portion is connectable with a bicycle peripheral product and adapted to allow a quick engagement and quick disengagement of the peripheral product; and
wherein said fastener retains said adapting device firmly in said compartment.

2. A front fork as claimed in claim 1 wherein said engagement hole is threadly receivable by said fastener.

3. A front fork as claimed in claim 1 where said adapting device includes an orifice receivable by said fastener whereby said adapting device is firmly fixed in said compartment by said fastener.

4. A front fork as claimed in claim 1 wherein said compartment includes a back wall against which said adapting device abut.

5. A front fork as claimed in claim 1 wherein said adapting device includes a base abutting against said bottom wall.

6. A front fork as claimed in claim 4 wherein said adapting device includes a backside abutting against said back wall.

7. A front fork as claimed in claim 1 wherein said bridge and tubes are integrally formed.

8. A front fork as claimed in claim 1 wherein said bridge and tubes are formed in two parts.

9. A front fork as claimed in claim 1 wherein said compartment defines an open space of a wedge-shaped configuration.

10. A front fork as claimed in claim 1 wherein said adapting device is formed having a wedge-shaped configuration.

11. A front fork as claimed in claim 1 wherein said adapting device includes a sloped side, with said hooking portion extends from said sloped side.

12. A front fork as claimed in claim 1 wherein said hooking portion includes a neck and at least two arms provided to clench a bicycle peripheral product and allow a quick engagement and quick disengagement of the peripheral product.

13. A front fork as claimed in claim 12 wherein said arms are parallel to said sloped side and disposed on said neck, with said each arm extending beyond the peripheral edge of the neck.
